(19) United States
(12) Patent Application Publication
(10) Pub. No.: US 2008/0055194 A1
(43) Pub. Date: Mar. 6, 2008

(54) METHOD AND SYSTEM FOR CONTEXT BASED USER INTERFACE INFORMATION PRESENTATION AND POSITIONING

(75) Inventors: DANIEL A. BAUDINO, LAKE WORTH, FL (US); DEEPAK P. AHYA, PLANTATION, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/469,069

(22) Filed: Aug. 31, 2006

(51) Int. Cl. G09G 5/00

(52) U.S. Cl. 345/8

(57) ABSTRACT

A method (90) and system (30) of presenting and positioning information on a user interface (56) includes a wearable display device, sensors (32) for detecting a context of use of the wearable display device using at least a vision sensor and a motion sensor, and a processor (42 or 50) coupled to the sensors and the wearable display device. The processor can analyze (93) a user's background view for areas suited for display of information in an analysis, and unobtrusively present (94) information within the user's field of view on the wearable display based on the context of use and the analysis. The processor can also determine (95) the type of information to unobtrusively present based on the context. The processor can optionally detect (92) the context of use by analyzing or recognizing a tool or an instrument used by a user of the wearable display.

### FIELD

This invention relates generally to user interfaces, and more particularly to a method and system of intelligently presenting and position information on a user interface.

### BACKGROUND

Wearable computers and different forms of wearable displays are increasingly used in various contexts including different gaming and work scenarios. The wearable displays can come in the form of eyeglass displays and head-up displays and can be used in conjunction with unobtrusive input devices such as wearable sensors. The users of these computers and displays in many instances perform routine actions while accessing information at the same time. Unfortunately, the information that might be displayed to such users can interfere with the users' habits or obscure their vision when providing feedback to them. Currently, such computers do not know much about user context and can result in cognition overload or obstruct critical visual information.

### SUMMARY

Embodiments in accordance with the present invention can provide a method and system for intelligently presenting feedback or information on a wearable display based on the context determined from sensors used in conjunction with the displays.

In a first embodiment of the present invention, a method of presenting and positioning information on a user interface can include detecting a context of use of a wearable display device using at least a vision sensor and a motion sensor, analyzing a user's background view for areas suited for display of information in an analysis, and unobtrusively presenting information within the user's field of view on the wearable display based on the context of use and the analysis. The method can further determine the type of information to unobtrusively present based on the context. The context of use can be detected by using positional sensors or by visually analyzing a user's actions, hand gestures, body positioning, leg movements, or environment. The context of use can also be detected by analyzing or recognizing a tool or an instrument used by a user of the wearable display. The method can further include the step of determining the display area where to display user interface information. Note, the step of analyzing the user's background can include delimiting at least a portion of the wearable display where user interface information is displayed or delimiting at least a portion of the wearable display where user interface information is prohibited from being displayed.

In a second embodiment of the present invention, a system of presenting and positioning information on a user interface can include a wearable display device, sensors for detecting a context of use of the wearable display device using at least a vision sensor and a motion sensor, and a processor coupled to the sensors and the wearable display device. The processor can be programmed to analyze a user's background view for areas suited for display of information in an analysis, and unobtrusively present information within the user's field of view on the wearable display based on the context of use and the analysis. The processor can also be programmed to determine the type of information to unobtrusively present based on the context. The processor can be programmed to detect the context of use by using positional sensors or by visually analyzing a user's actions, hand gestures, body positioning, leg movements, or environment. The processor can also detect the context of use by analyzing or recognizing a tool or an instrument used by a user of the wearable display. The processor can further be programmed to determine the display area where to display user interface information to a user. Note, analysis of the user's background can include delimiting at least a portion of the wearable display where user interface information is displayed or delimiting at least a portion of the wearable display where user interface information is prohibited from being displayed.

In a third embodiment of the present invention, a wearable display system can include a plurality of sensors including a camera module, a wearable display for presenting a user interface on the wearable display, and a processor coupled to the plurality of sensors and the wearable display. The processor can be programmed to analyze positioning of body portions of a user, perform image recognition of a view currently seen by the camera module, determine a context from the positioning analyzed and image recognition, and unobtrusively present context pertinent information within a user's field of view on the wearable display based on the context. The processor can be further programmed to detect the context by using positional sensors or by visually analyzing a user's actions, hand gestures, body positioning, leg movements, or environment. The processor can also be programmed to detect the context by analyzing or recognizing a tool or an instrument used by a user of the wearable display. The processor can determine a display area within the wearable display to display user interface information to a user. The processor can also delimit at least a portion of the wearable display where user interface information is displayed or delimit at least a portion of the wearable display where user interface information is prohibited from being displayed based on the analysis of a user's background view on the wearable display.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. “Unobtrusively” should be understood herein as generally allowing a user to generally view or operate equipment without or with a diminished level of interference or distraction from additional output being provided to the user.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system. The “processor” as described herein can be any suitable component or combination of components, including any suitable hardware or software, that are capable of executing the processes described in relation to the inventive arrangements. The term “suppressing” can be defined as reducing or removing, either partially or completely.

Other embodiments, when configured in accordance with the inventive arrangements disclosed herein, can include a system for performing as well as a machine readable storage for causing a machine to perform the various processes and methods disclosed herein.

### BRIEF DESCRIPTION OF THE DRAWINGS

FIG. 1 is a depiction of a user and a wearable computer and display in accordance with an embodiment of the present invention.

FIG. 2 is a screen shot of a wearable display in accordance with an embodiment of the present invention.

FIG. 3 is a block diagram of a system presenting and positioning information on a user interface in accordance with an embodiment of the present invention.

FIG. 4 is another screen shot of the wearable display illustrating delineated areas on the display in accordance with an embodiment of the present invention.

FIG. 5 is the screen shot of FIG. 4 illustrated without the delineated areas in accordance with an embodiment of the present invention.

FIG. 6 is a screen shot of an existing wearable display illustrating how the user interface information obscures a user's field of vision.

FIG. 7 is a screen shot of a wearable display illustrating delineated areas on the display in accordance with an embodiment of the present invention.

FIG. 8 is a screen shot of a wearable display illustrating recognition of a tool and a predictable path of the tool in order to delineate areas on the display in accordance with an embodiment of the present invention.

FIG. 9 is a flow chart illustrating a method of presenting and positioning information on a user interface in accordance with an embodiment of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Embodiments herein can be implemented in a wide variety of exemplary ways in various devices such as in personal digital assistants, cellular phones, laptop computers, desktop computers, digital video recorder, electronic inventory devices or scanners and the like. Generally speaking, pursuant to these various embodiments, a method or system herein can further extend the concept of user interfaces that can include wearable computers that act as intelligent agents advising, assisting and guiding users to perform their tasks. A relevant use case for this type of system can for example operate well where a user performs predictable or known tasks, such as courier delivery, maintenance and repairs, quality inspections, logistics, inventory and the like.

With predictable or routine activities, wearable computers can further enhance their functionality by adding support to assist, guide and/or advise the user and even predicts the user's behavior. Such a system can learn, understand and recognize patterns that constitute a user's behavior; then these patterns can be applied to generate a user's context under various embodiments herein. Based on this context, the system can also predict, with some degree of certainty, what the user wants to do next.

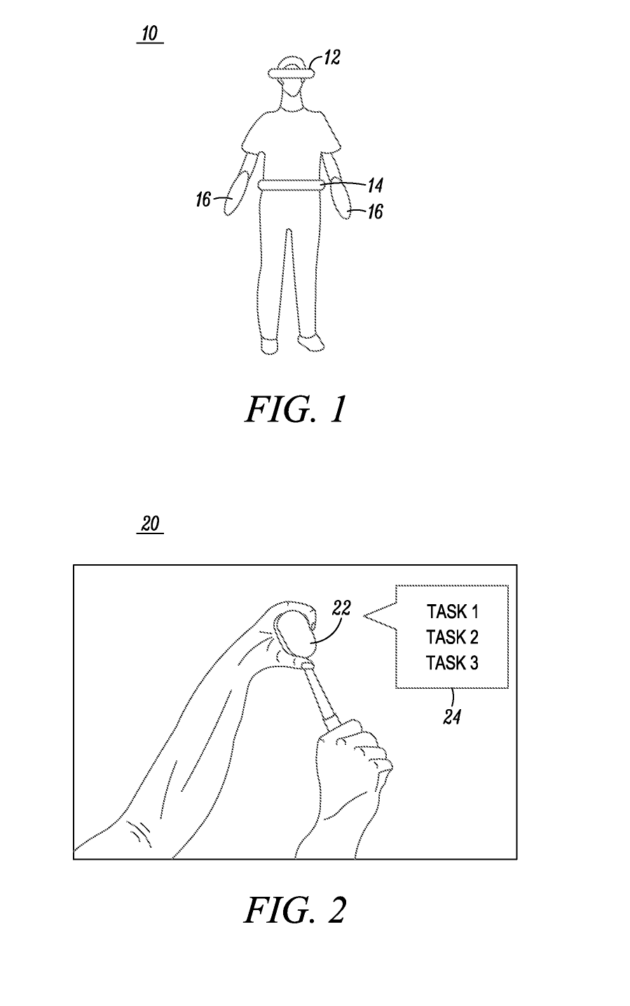

When generating user advice, a system 10 as illustrated in FIG. 1 can analyze a user movement's to enable the system to make a decision on what device (e.g., heads up display, eyeglasses, or possibly a speaker) to provide a presentation. The system 10 can also analyze and make a decision as to where on the display to provide the advice without obstructing the users view. The system 10 can include a wearable display 12 that can be a projection display. The display 12 can also include a head and/or eye movement detector. The system 10 can further include a main computer or processing system 14 as well as a plurality of sensors 16 that can detect movement or positioning of hands or other body parts or portions. As shown, the sensor can be distributed around the user's body. Based on the type and number of sensors, different motion or positioning (e.g., walking, running, sitting, finger movements, etc.) can be detected as can be contemplated within the various embodiments The system 10 can first collect the data from the different sensors 16 distributed around the body and then use that information to make a decision. For example, if the user has their hands or tools 22 in front their eyes as illustrated in the screen shot 20 of FIG. 2, then the advice (i.e. task instructions) or user interface information 24 can be displayed in unobtrusive manner.

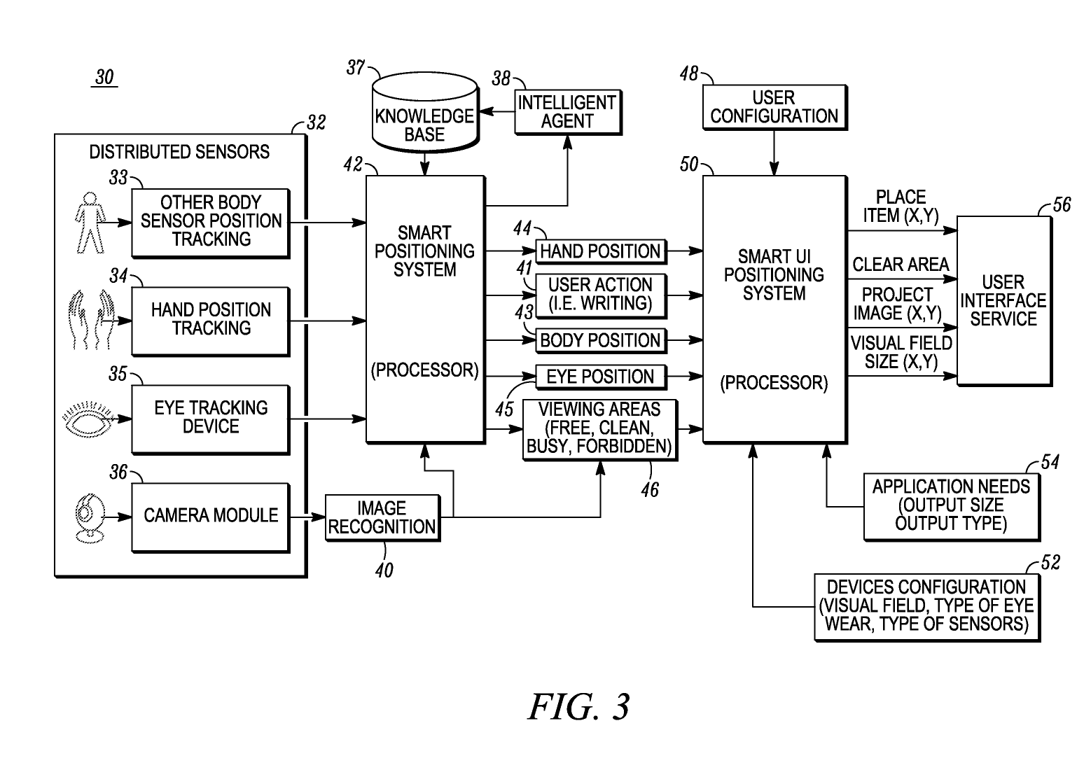

Referring to FIG. 3, a system 30 of presenting and positioning information on a user interface 56 can include a wearable display device (not shown), sensors 32 for detecting a context of use of the wearable display device using at least a vision sensor and a motion sensor, and a processor (42 or 50) coupled to the sensors and the wearable display device. The processor can be programmed to analyze a user's background view for areas suited for display of information in an analysis, and unobtrusively present information within the user's field of view on the wearable display based on the context of use and the analysis. The processor can also be programmed to determine the type of information to unobtrusively present based on the context. The processor can be programmed to detect the context of use by using positional sensors or by visually analyzing a user's actions, hand gestures, body positioning, leg movements, or environment. The processor can also detect the context of use by analyzing or recognizing a tool or an instrument used by a user of the wearable display. The processor can further be programmed to determine the display area where to display user interface information to a user. Note, analysis of the user's background can include delimiting at least a portion of the wearable display where user interface information is displayed or delimiting at least a portion of the wearable display where user interface information is prohibited from being displayed.

The sensors 32 can include a body positioning or tracking sensor 33, a hand positioning or tracking sensor 34, an eye tracking device 35, or a camera module 36. The sensor 32 can provide inputs to a processor 42 such as a smart positioning system. The camera module 36 can also provide input to an image recognition processor 40 before providing input to the processor 42. The hand sensors 34 can detect hand movements and estimate a 3D hand position, a head sensor such as sensor 33 can detect head position and corresponding movements and the eye tracking sensor 35 can detect what the user is looking at or at least the direction or position where the user is looking. The camera module 36 detects the main moving area that the user is looking at and helps to detect those areas with less activity on the user vision field (of the display). Based on user movement and user vision, the system can estimate what might be the best way to present the user interface information to the user.

The system 30 can further include an intelligent agent 38 that can inform the system with hand movement and eye movement prediction based on past data stored in a knowledge base 37. The processor 42 in the form of the smart positioning system can provide inputs 41, 43, 44, 45, or 46 to the processor 50 in the form of a smart UI positioning system. The inputs can help determine the areas that are good or bad for placing visual feedback on the user interface or display. The good and bad areas can also be determined by analyzing high or low contrast areas. For example, a white background or an image of an area having uniformity such as a plain background can be considered a good area. An area that is too bright might be considered a bad area. The inputs can also indicate the body parts that might be interfering on the visual field (e.g., hand position) and where the user eyes are pointing towards. The Smart UI positioning system also gets information from the device configuration 52 (e.g., type of sensors, visual field of the eye wear, type of eye wear, etc.). The application settings 54 can also provide parameters to the processor 50 such as size of output to display, type of information to display (e.g., text, voice, images, etc.). The user might also want to configure where he or she desires the information to be displayed, or recommends the system to stay away from displaying user interface information in certain areas (e.g., low visibility areas).

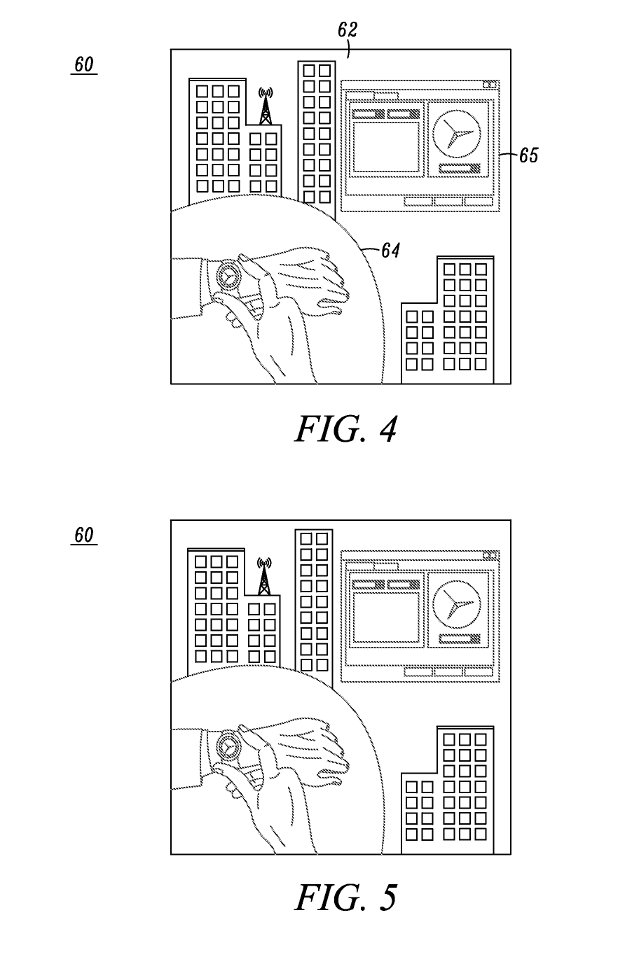

To make a good decision the system can determine the limits of peripheral vision where the user and device configuration can contribute to calculating the peripheral vision parameters. For example, the type of eye wear device used may limit the peripheral vision parameters. Once the system understands several factors by collecting the data from the distributed sensors, the system 30 can form delineations for appropriate user interface outputs. The factors can include what the peripheral vision parameters are, what the user is currently looking at, what the main activity (and the area of the main activity) are on the user's vision field and where are the user hands and eyes at any given moment. Based on all or a portion of these factors and possibly others, the system can calculate what is a forbidden area 64 and a free area 62 for presenting a user interface output 65 on a screen output 60 as shown in FIG. 4. For example, FIG. 4 can show the calculated forbidden area 64 as the area with the highest movement or vision and hand position/movement and the free area 62 as an area with significantly less movement so that the system knows where to place the application output 65. The free area 62 can also be delimited by the type of eye wear used. The eye wear estimates the existing visual area based on the visual field taking the peripheral vision into account. After the calculations, the application in charge of displaying the information to the user, knows where to place all the UI feedback as illustrated in FIG. 5 where the delineations have been removed. Data displayed will depend on the application used or the type of feedback needed.

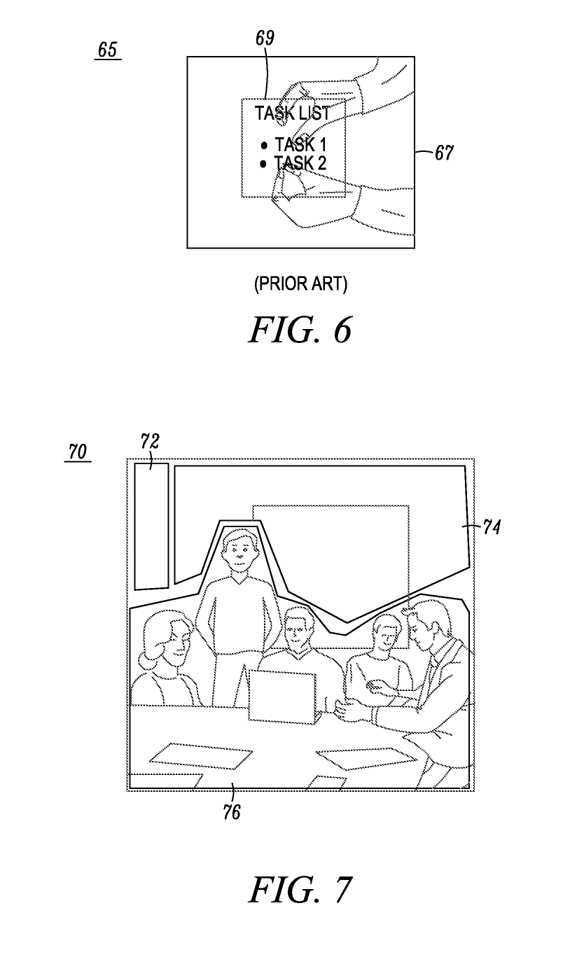

A background analyzer using pattern recognition can be used to define the best area to place the feedback on the free area for UI. For example, if a whiteboard is on the visible area and away from the user spot, then the positioning system uses the whiteboard area for the feedback. Also, the background analyzer defines where a less crowded area may be or an area further away from any moving object on the background in order to place the feedback optimally for viewing by the user. In contrast, FIG. 6 illustrates a screen shot 65 of an existing system that does not understand the user surroundings and hence obstructs the view of the user when posting information 69 on the heads up display/eye wear 67

The image recognition processor 40 of FIG. 3 can help the system determine where are the best areas to display information on the display. For example, if the area is low in contrast, or not crowded with objects, then those are the preferred areas for the UI to display the output as demonstrated by area 74 of screen shot 70 of FIG. 7. The system also recognizes the brightness of an area 72 to avoid display information on those areas. For example, if a window is present in the room or a lamp or bulb is viewed directly in the field of view. Crowded areas or areas with significant motion such as area 76 should also be avoided with respect to displaying user interface information.

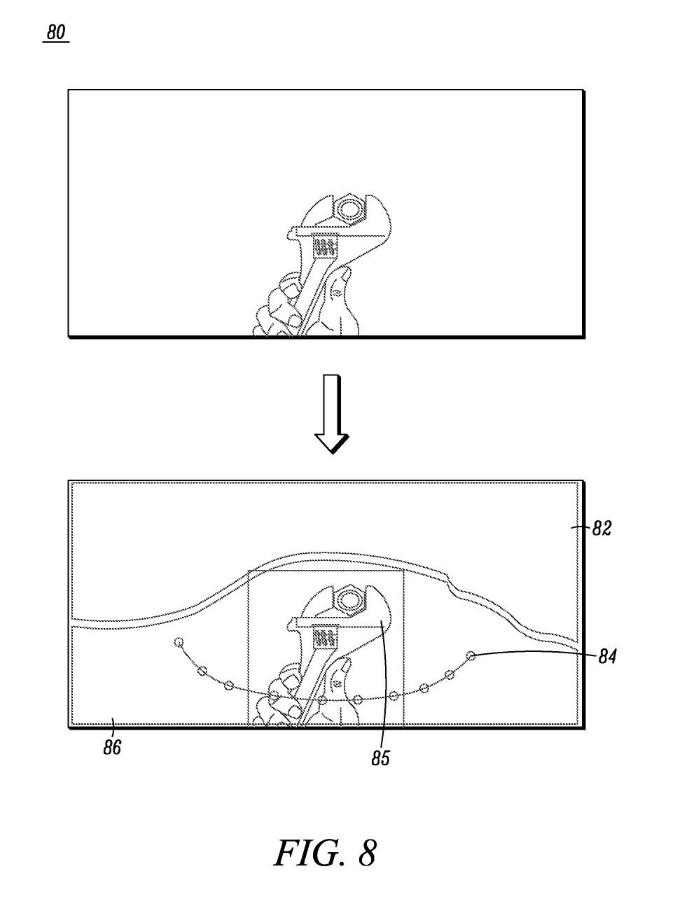

The intelligent agent 38 of FIG. 3 can monitors the user's movement to predict where the hands and eye will be depending on the operation or action. Then UI system tries not to display information on those predicted movement areas. For example, referring to the screen shot 80 of FIG. 8, if the user is performing an operation using a tool 85, the analysis can look at the action performed (such as setting aside a tool, picking up a tool, or using the tool in its typical operation) in order to more accurately determine the free areas 82 and forbidden areas 86. More particularly as shown, if the user is using a wrench (85) in a normal fashion, the system can determine a predicted path 84 in the analysis for delineating areas for display of information.

In another embodiment, if the user utilizes the entire vision field (determined by the user) or the smart agent detects that the entire area is used for the specific task, then the system can suppress a visual user interface output and can optionally opt for an audible output. For example, if the user is using specific eyewear with a small visual field such as infrared goggles, then any visual feedback will interfere. In such an instance, the positioning system can delegate the UI to a multimodal system by blocking the display modality (output). The multimodal component can then, give verbal instructions to the user, or any other type of output modality. Also, if the task requires the user to move, walk, or run (as detected by the movement sensors), any displayed message might be very intrusive and impossible to read. Once again, the modality will adapt to the best output possible.

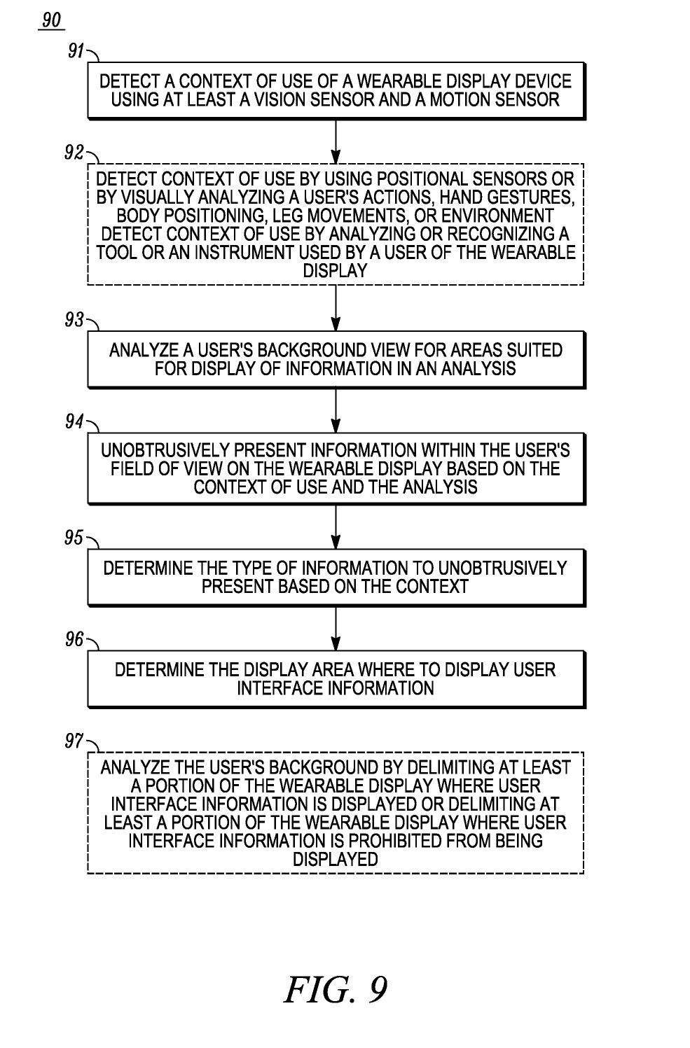

Referring to FIG. 9, a method 90 of presenting and positioning information on a user interface can include the step 91 of detecting a context of use of a wearable display device using at least a vision sensor and a motion sensor, analyzing a user's background view for areas suited for display of information in an analysis at step 93, and unobtrusively presenting information within the user's field of view on the wearable display based on the context of use and the analysis at step 94. The method 90 can further determine at step 95 the type of information to unobtrusively present based on the context. The context of use can optionally be detected at step 92 by using positional sensors or by visually analyzing a user's actions, hand gestures, body positioning, leg movements, or environment. The context of use can also be detected by analyzing or recognizing a tool or an instrument used by a user of the wearable display. The method 90 can further include the step 96 of determining the display area where to display user interface information. Note, the step of analyzing the user's background can include the step 97 of delimiting at least a portion of the wearable display where user interface information is displayed or delimiting at least a portion of the wearable display where user interface information is prohibited from being displayed.

In summary, a system in accordance with the embodiments can perform one or more of the functions of reading distributed sensors around the body and the associated data, understanding a user's movements to selectively identify areas suitable to feed or present the user with visual information and to further decide what type of information to provide the user, understanding where to place (both in terms of device and display area on such device) a UI output, and further selecting the right output (display, speaker, etc.) based on the user's visual field.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present invention, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions, or that which receives and executes instructions from a propagated signal so that a device connected to a network environment can send or receive voice, video or data, and to communicate over the network using the instructions. The instructions may further be transmitted or received over a network via a network interface device.

While the machine-readable medium can be an example embodiment in a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

In light of the foregoing description, it should be recognized that embodiments in accordance with the present invention can be realized in hardware, software, or a combination of hardware and software. A network or system according to the present invention can be realized in a centralized fashion in one computer system or processor, or in a distributed fashion where different elements are spread across several interconnected computer systems or processors (such as a microprocessor and a DSP). Any kind of computer system, or other apparatus adapted for carrying out the functions described herein, is suited. A typical combination of hardware and software could be a general purpose computer system with a computer program that, when being loaded and executed, controls the computer system such that it carries out the functions described herein.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A method of presenting and positioning information on a user interface, comprising the steps of:
detecting a context of use of a wearable display device using at least a vision sensor and a motion sensor;
analyzing a user's background view for areas suited for display of information in an analysis; and
unobtrusively presenting information within the user's field of view on the wearable display based on the context of use and the analysis.

2. The method of claim 1, wherein the method further comprises the step of determining the type of information to unobtrusively present based on the context.

3. The method of claim 1, wherein the step of detecting the context of use comprises the step of visually analyzing a user's actions, hand gestures, body positioning, leg movements, or environment.

4. The method of claim 1, wherein the step of detecting the context of use comprises the step of analyzing a user's actions, hand gestures, body positioning, leg movements, or environment using positional sensors.

5. The method of claim 1, wherein the step of detecting the context of use comprises the step of analyzing or recognizing a tool or an instrument used by a user of the wearable display.

6. The method of claim 1, wherein the method further comprises the step of determining the display area where to display user interface information.

7. The method of claim 1, wherein the step of analyzing the user's background comprises delimiting at least a portion of the wearable display where user interface information is displayed or delimiting at least a portion of the wearable display where user interface information is prohibited from being displayed.

8. A system of presenting and positioning information on a user interface, comprising:
a wearable display device;
sensors for detecting a context of use of the wearable display device using at least a vision sensor and a motion sensor;
a processor coupled to the sensors and the wearable display device, wherein the processor is programmed to:
analyze a user's background view for areas suited for display of information in an analysis; and
unobtrusively present information within the user's field of view on the wearable display based on the context of use and the analysis.

9. The system of claim 8, wherein the processor is further programmed to determine the type of information to unobtrusively present based on the context.

10. The system of claim 8, wherein the processor is further programmed to detect the context of use by visually analyzing a user's actions, hand gestures, body positioning, leg movements, or environment.

11. The system of claim 8, wherein the processor is further programmed to detect the context of use by analyzing a user's actions, hand gestures, body positioning, leg movements, or environment by using positional sensors.

12. The system of claim 8, wherein the processor is further programmed to detect the context of use by analyzing or recognizing a tool or an instrument used by a user of the wearable display.

13. The system of claim 8, wherein the processor is further programmed to determine the display area wherein to display user interface information to a user.

14. The system of claim 8, wherein the processor analyzes the user's background by delimiting at least a portion of the wearable display where user interface information is displayed or by delimiting at least a portion of the wearable display where user interface information is prohibited from being displayed.

15. A wearable display system, comprising:
a plurality of sensors including a camera module;
a wearable display for presenting a user interface on the wearable display; and
a processor coupled to the plurality of sensors and the wearable display, wherein the processor is programmed to:
analyze positioning of body portions of a user;
perform image recognition of a view currently seen by the camera module;
determine a context from the positioning analyzed and image recognition; and
unobtrusively present context pertinent information within a user's field of view on the wearable display based on the context.

16. The system of claim 15, wherein the processor is further programmed to detect the context by visually analyzing a user's actions, hand gestures, body positioning, leg movements, or environment.

17. The system of claim 15, wherein the processor is further programmed to detect the context by analyzing a user's actions, hand gestures, body positioning, leg movements, or environment by using positional sensors.

18. The system of claim 15, wherein the processor is further programmed to detect the context by analyzing or recognizing a tool or an instrument used by a user of the wearable display.

19. The system of claim 15, wherein the processor is further programmed to determine a display area within the wearable display to display user interface information to a user.

20. The system of claim 15, wherein the processor analyzes a user's background view by delimiting at least a portion of the wearable display where user interface information is displayed or by delimiting at least a portion of the wearable display where user interface information is prohibited from being displayed.
